(19) United States
(12) Patent Application Publication
(10) Pub. No.: US 2025/0172389 A1
(43) Pub. Date: May 29, 2025

(54) ELECTRON TUBE AND SPECTROSCOPE

(71) Applicant: HAMAMATSU PHOTONICS K.K., Hamamatsu-shi (JP)

(72) Inventors: Makoto SUZUKI, Hamamatsu-shi (JP); Junji Okuma, Hamamatsu-shi (JP); Mitsuhiro Nagao, Hamamatsu-shi (JP)

(73) Assignee: HAMAMATSU PHOTONICS K.K., Hamamatsu-shi (JP)

(21) Appl. No.: 18/895,599

(22) Filed: Sep. 25, 2024

(30) Foreign Application Priority Data
Nov. 29, 2023 (JP) 2023-201803

(51) Int. Cl. G01B 15/00; G01J 3/28; H01J 43/04

(52) U.S. Cl. CPC G01B 15/00; G01J 3/28; H01J 43/04

(57) ABSTRACT

An electron tube used by being attached to an external device, including a housing having a light incident window including a light incident surface and allowing light from the external device to be incident thereon through the light incident surface, a photoelectric conversion portion disposed inside the housing to face the light incident window, and configured to emit electrons in response to the light incident from the light incident window, an electron multiplier portion disposed inside the housing and configured to multiply electrons emitted from the photoelectric conversion portion, and a positioning member formed separately from the light incident window and fixed to the light incident surface, the positioning member having a light passing portion passing the light from the external device toward the light incident surface, in which the positioning member has a reference portion serving as a reference for mechanical positioning with respect to the external device.

### TECHNICAL FIELD

The present disclosure relates to an electron tube and a spectroscope.

### BACKGROUND

Japanese Patent No. 6508140 describes a photomultiplier tube including a main body and a support provided at an end of the main body. The main body includes a light-transmitting cylindrical member and a photomultiplier section accommodated in the cylindrical member and including a cathode and a dynode. The cathode receives light incident from outside the cylindrical member and emits photoelectrons. The emitted photoelectrons are incident on the dynode.

This photomultiplier tube is attached to a measurement device having a light-emitting portion that causes an analytical sample to emit light. Specifically, the photomultiplier tube is fixed by inserting bolts into a fixing hole in the support and a through-hole in a facing member of the measurement device provided at a position corresponding to the fixing hole.

### SUMMARY

Incidentally, in general, for example, the photomultiplier tube has difficulty in achieving mechanical precision as designed due to influences related to manufacture such as tolerance or assembly accuracy of a component, and a heating process during manufacture in some cases. For this reason, individual differences may occur, and for example, even when attached to an external device such as the above-mentioned measurement device in the same way, a difference occurs in an optical positional relationship. Therefore, even for the same input signal, there may be a difference in an output signal displayed by the external device in some cases. In such a case, fine-tuning of a state of being attached to the external device is necessary, which is an adjustment operation performed while operating the external device, and thus is not easy.

Therefore, an object of one aspect of the disclosure is to provide an electron tube and a spectroscope that can be positioned easily and highly precisely.

An electron tube according to an aspect of the disclosure is [1] “an electron tube used by being attached to an external device, the electron tube including a housing having a light incident window including a light incident surface and allowing light from the external device to be incident thereon through the light incident surface, a photoelectric conversion portion disposed inside the housing to face the light incident window, and configured to emit electrons in response to the light incident from the light incident window, an electron multiplier portion disposed inside the housing and configured to multiply electrons emitted from the photoelectric conversion portion, and a positioning member formed separately from the light incident window and fixed to the light incident surface, the positioning member having a light passing portion passing the light from the external device toward the light incident surface, in which the positioning member has a reference portion serving as a reference for mechanical positioning with respect to the external device”.

The electron tube includes the housing including the light incident window, the photoelectric conversion portion and the electron multiplier portion disposed inside the housing, and the positioning member fixed to the light incident surface of the light incident window. Further, the positioning member has the reference portion serving as a reference for mechanical positioning with respect to the external device. The positioning member is configured separately from the light incident window and is fixed to the light incident window. Therefore, after the positioning member is completed as the electron tube (after a manufacturing process for the electron tube is completed), that is, after any changes in mechanical precision due to influences related to manufacture of the electron tube are determined, the positioning member can be fixed to the light incident window in a desired state. For this reason, the reference portion of the positioning member rarely receives influence related to manufacture of the electron tube. Therefore, when attaching the electron tube to the external device, by using the reference portion of the positioning member, it is possible to perform high-precision positioning according to mechanical precision of the reference portion. Therefore, according to the electron tube, it is possible to easily and highly precisely perform positioning with respect to the external device.

An electron tube according to an aspect of the disclosure may be [2] “the electron tube according to [1], in which the positioning member is fixed to the light incident surface so that the light passing portion faces the photoelectric conversion portion and the light passing through the light passing portion is incident on a desired region of the photoelectric conversion portion”. In this case, it is possible to perform high-precision positioning so that the light from the external device is guided to an appropriate region of the photoelectric conversion portion.

An electron tube according to an aspect of the disclosure may be [3] “the electron tube according to [1] or [2], in which a marker is formed on at least one of the positioning member, a substrate on which the photoelectric conversion portion is provided, and the electron multiplier portion”. In this case, it is possible to perform high-precision positioning using the marker.

An electron tube according to an aspect of the disclosure may be [4] “the electron tube according to any one of [1] to [3], in which the electron multiplier portion has a plurality of channels arranged in at least one direction and used to multiply each of electrons emitted from the photoelectric conversion portion in response to each of a plurality of beams of the light incident from the light incident window”. In this way, when the electron multiplier portion has the plurality of channels (which is multiple channels), it is more effective to enable easy and highly-precision positioning with respect to the external device. For example, when a multi-channel electron tube is attached to a spectroscope as an external device, it is necessary to position each channel of the electron tube at an arrival position of each wavelength of light dispersed by the spectroscope. In this case, it is preferable to be able to easily perform highly-precision positioning of the electron tube with respect to the spectroscope.

An electron tube according to an aspect of the disclosure may be [5] “the electron tube according to any one of [1] to [4], in which the positioning member has an optical element provided on the light passing portion and configured to receive incidence of the light from the external device and to emit the light toward the light incident surface”. In this way, when the optical element is added to the positioning member in charge of a function of performing high-precision positioning with respect to the external device, light can be guided with high precision by the optical element disposed with high precision.

An electron tube according to an aspect of the disclosure may be [6] “the electron tube according to any one of [1] to [5], in which the reference portion has a position reference serving as a reference for a position with respect to the external device, and an angle reference serving as a reference for an angle with respect to the external device”. In this case, the position and the angle with respect to the external device can be determined easily and highly precisely.

An electron tube according to an aspect of the disclosure may be [7] “the electron tube according to any one of [1] to [6], in which the reference portion includes at least one of a protrusion, a hole, a notch, and an end surface formed on the positioning member”. In this case, the reference portion can be constructed using a simple mechanical structure.

An electron tube according to an aspect of the disclosure may be [8] “the electron tube according to any one of [1] to [7], in which the positioning member has a first surface on a side of the light incident surface and a second surface on an opposite side from the first surface, and an anti-reflection film is formed on at least one of the first surface and the second surface”. In this case, it is possible to reduce reflection of light on the positioning member.

An electron tube according to an aspect of the disclosure may be [9] “the electron tube according to any one of [1] to [4], in which an opening exposing the light incident surface toward an outside is formed in the light passing portion”. In this case, the light from the external device can be made incident on the light incident surface without undergoing reflection, refraction, etc. at the positioning member.

An electron tube according to an aspect of the disclosure may be [10] “the electron tube according to [4], in which the positioning member has an optical element provided on the light passing portion and configured to receive incidence of the light from the external device and to emit the light toward the light incident surface, and the optical element includes a plurality of optical structures aligned with the plurality of channels, respectively”. In this case, it is possible to efficiently make light incident on each of the plurality of channels of the electron multiplier portion.

An electron tube according to an aspect of the disclosure may be [11] “the electron tube according to [10], further including a light-converging element provided on a surface of the optical element on an opposite side from the light incident surface and having a light-converging structure in a plane intersecting an arrangement direction of the channels”. In this case, a field of view in the plane intersecting the arrangement direction of the plurality of channels can be expanded.

An electron tube according to an aspect of the disclosure is [12] “a spectroscope including a spectroscopic unit as the external device for dispersing detection light into light of a plurality of wavelengths and emitting the light, and the electron tube according to any one of [1] to [11]”. In this case, it is possible to position the electron tube with respect to the spectroscopic unit easily and highly precisely.

A spectroscope according to an aspect of the disclosure may be [13] “the spectroscope according to [12], in which the spectroscopic unit includes a dispersion element disposed on an optical path of the detection light and used to disperse the detection light into the light of the plurality of wavelengths, and a wavelength selection element disposed at a previous stage of the dispersion element on the optical path of the detection light and configured to reflect or absorb light of a specific wavelength band of the detection light”. In this case, it is possible to reflect or absorb light serving as noise for the detection light using the wavelength selection element.

According to an aspect of the disclosure, it is possible to provide an electron tube and a spectroscope that can be positioned easily and highly precisely.

### BRIEF DESCRIPTION OF THE DRAWINGS

FIG. 1 is a schematic view illustrating a spectroscope according to this embodiment.

FIG. 2 is a cross-sectional view of an electron tube and a case accommodating the electron tube.

FIG. 3 is a plan view of the case accommodating the electron tube.

FIG. 4 is a perspective view of the electron tube.

FIG. 5 is a plan view of the electron tube.

FIG. 6 is a schematic cross-section view of the electron tube.

FIG. 7 is a schematic plan view of an electron multiplier portion.

FIG. 8A is a plan view of a positioning member. FIG. 8B is a plan view of the electron multiplier portion. FIG. 8C is a plan view of a state in which the positioning member is disposed on the electron multiplier portion.

FIG. 9 is a drawing schematically illustrating a state in which light emitted from a cylindrical lens array is incident on a plurality of channels of the electron multiplier portion.

FIGS. 10A and 10B are drawings for describing a method of positioning the positioning member not using a reference line.

FIGS. 11A and 11B are drawings illustrating modified examples of the positioning member.

FIGS. 12A and 12B are drawings illustrating modified examples of the positioning member.

FIG. 13 is a drawing illustrating a modified example of the positioning member.

FIG. 14 is a drawing illustrating a modified example of the positioning member.

FIG. 15 is a cross-sectional view of an electron tube and a case accommodating the electron tube according to a modified example.

FIG. 16A is a schematic view illustrating an electron tube which is a photomultiplier tube according to a modified example. FIG. 16B is a plan view of a positioning member of FIG. 16A. FIG. 16C is a plan view of an electron multiplier portion of FIG. 16A.

FIG. 17 is a schematic view of an electron tube which is a photomultiplier tube according to a modified example.

FIG. 18 is a plan view of a positioning member according to the modified example of FIG. 17.

### DETAILED DESCRIPTION

An electron tube and a spectroscope according to one embodiment will be described below with reference to the drawings. Note that, in the description of the drawings, the same or corresponding elements are assigned the same reference numerals, and duplicated descriptions may be omitted. Further, each drawing may illustrate an orthogonal coordinate system including an axis defining a first direction D1, an axis defining a second direction D2 intersecting the first direction D1, and an axis defining a third direction intersecting the first direction D1 and the second direction D2.

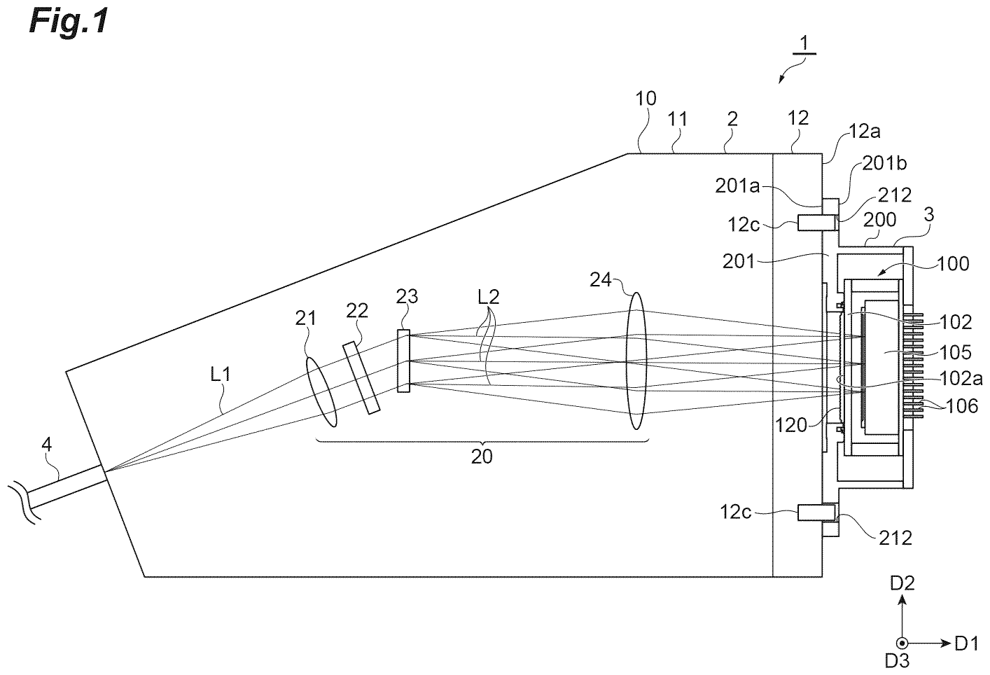

FIG. 1 is a schematic cross-sectional view of a spectroscope according to this embodiment. For example, the spectroscope 1 illustrated in FIG. 1 is used for spectroscopic measurement of weak light such as fluorescence and Raman scattering light, and is used in particular in a flow cytometer.

The spectroscope 1 illustrated in FIG. 1 includes a spectroscopic unit (external device) 2 and a detection unit 3. The spectroscopic unit 2 disperses detection light L1 emitted from an optical fiber 4 into light L2 having a plurality of wavelengths, and emits the dispersed light L2 toward the detection unit 3.

The spectroscopic unit 2 has a housing 10 and an optical system 20. The housing 10 has a storage portion 11 and an attachment portion 12. The storage portion 11 accommodates the optical system 20. The storage portion 11 includes one end to which the optical fiber 4 is attached and on which the detection light L1 guided by the optical fiber 4 is incident, and the other end from which each beam of the light L2 after dispersion is emitted. The attachment portion 12 is disposed at the other end. The attachment portion 12 has a surface 12a on the opposite side from the storage portion 11. A plurality of positioning pins 12c to be inserted into through-holes 212 described later is formed on the surface 12a to position the detection unit 3 with respect to the spectroscopic unit 2 with high precision.

The optical system 20 has a collimating lens 21, a filter (wavelength selection element) 22, a diffraction grating (dispersion element) 23, and an imaging lens 24. The detection light L1 emitted from the optical fiber 4 passes through the collimating lens 21 and the filter 22 in this order, and is incident on the diffraction grating 23. The collimating lens 21 emits the detection light L1 emitted from the optical fiber 4 toward the filter 22 while collimating the detection light L1. Note that in this embodiment, each of the collimating lens 21, the filter 22, the diffraction grating 23, and the imaging lens 24 of the optical system 20 is configured as a single optical element. However, each of these may be configured as a plurality of optical elements.

The filter 22 is disposed at a previous stage of the diffraction grating 23 on an optical path of the detection light L1. Specifically, the filter 22 is disposed between the collimating lens 21 and the diffraction grating 23 on the optical path of the detection light L1. The filter 22 selects a wavelength of light traveling to the diffraction grating 23 by reflecting or absorbing light of a specific wavelength band included in the detection light L1 (for example, excitation light of an object to be measured in the spectroscopic unit 2). In this way, it is possible to reflect or absorb light serving as noise for the detection light L1 using the filter 22.

As an example, the diffraction grating 23 is a transmissive diffraction grating that disperses the detection light L1 incident from the filter 22 into the light L2 having a plurality of wavelength bands and emits each beam of the light L2 toward the imaging lens 24. The light L2 emitted from the diffraction grating 23 passes through the imaging lens 24 and is incident on a light incident surface 102a of the electron tube 100, which will be described later. Note that the diffraction grating 23 may be a reflective diffraction grating, or a prism may be used instead of the diffraction grating. The imaging lens 24 images the light L2 emitted from the diffraction grating 23 on the light incident surface 102a, which will be described later.

The detection unit 3 has an electron tube 100 and a case 200. The electron tube 100 is, for example, a hybrid photodetector (HPD). The electron tube 100 detects light emitted from the spectroscopic unit 2. The electron tube 100 is attached to the spectroscopic unit 2 to face the imaging lens 24. Specifically, the electron tube 100 is fixed to the attachment portion 12 of the spectroscopic unit 2 via the case 200 in a state of being accommodated in the case 200. In the following, a configuration of the case 200 will be described first, and then a configuration of the electron tube 100 will be described. In addition, a direction in which the imaging lens 24 faces the light incident surface 102a described later (that is, a direction intersecting the light incident surface 102a) is defined as the first direction D1.

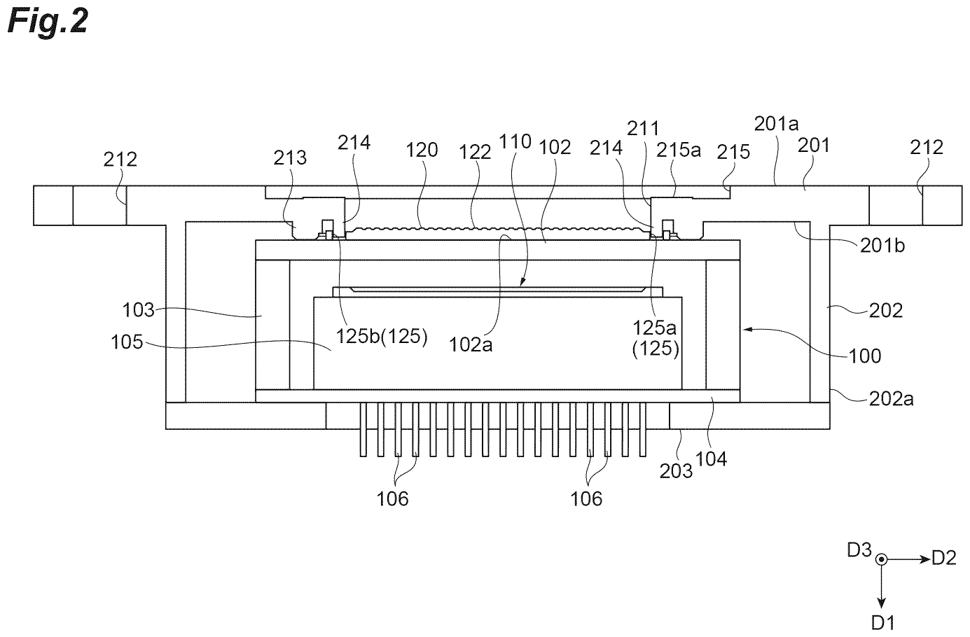

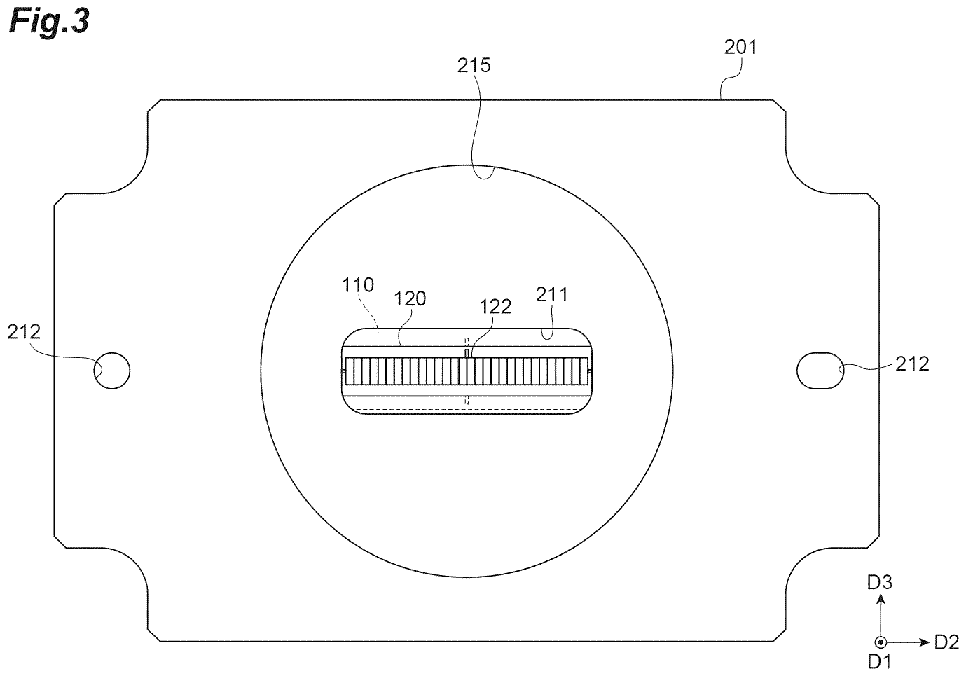

The configuration of the case 200 will be described with reference to FIGS. 1 to 3. FIG. 2 is a cross-sectional view of the detection unit 3. FIG. 3 is a view of the detection unit 3 as seen from the imaging lens 24 side.

The case 200 has a top plate 201, a side wall 202, and a cover member 203. The case 200 accommodates the electron tube 100.

The top plate 201 is formed in a plate shape. The top plate 201 has a first surface 201a and a second surface 201b on the opposite side from the first surface 201a. The first surface 201a faces the surface 12a of the attachment portion 12 in the first direction D1. The second surface 201b faces the light incident surface 102a of the electron tube 100 in the first direction D1. As an example, the top plate 201 is formed in a rectangular shape having four corners each cut out in a semicircular shape when viewed from the first direction D1.

The top plate 201 has an opening 211, a plurality of through-holes 212, a projection 213, a pair of protrusions 214, and a recess 215.

When viewed from the first direction D1, the opening 211 exposes a positioning member 120 (described later) of the electron tube 100. As a result, the light L2 emitted from the spectroscopic unit 2 is incident on the positioning member 120 via the opening 211.

The plurality of through-holes 212 is through-holes formed in the top plate 201 along the first direction D1. The plurality of through-holes 212 is mechanical references that define a positional relationship between the spectroscopic unit 2 and the case 200 (detection unit 3). The plurality of through-holes 212 is formed at positions corresponding to the plurality of positioning pins 12c of the attachment portion 12 when viewed from the first direction D1. The detection unit 3 is fixed to the attachment portion 12 via the top plate 201 by inserting the positioning pins 12c into the through-holes 212. An insertion structure of the positioning pins 12c and the through-holes 212 can be formed so that outer wall surfaces of the positioning pins 12c and inner wall surfaces of the through-holes 212 are separated by a gap of about several μm, and thus extremely high-precision positioning can be performed. Further, the spectroscopic unit 2 and the case 200 (detection unit 3) are reliably joined together by a screw-fitting structure using screws and screw holes (not illustrated) while being positioned by the insertion structure of the positioning pins 12c and the through-holes 212. In this way, the positional relationship between the spectroscopic unit 2 and the case 200 (detection unit 3) is mechanically determined.

The projection 213 is formed on the second surface 201b of the top plate 201. The projection 213 is formed inside a side tube 103 (described later) of the electron tube 100 when viewed from the first direction D1. The projection 213 is in contact with the light incident surface 102a of the electron tube 100. The projection 213 is formed, for example, in a circular ring shape when viewed from the first direction D1.

The pair of protrusions 214 is formed on the second surface 201b of the top plate 201. The pair of protrusions 214 is mechanical references for defining a positional relationship between the electron tube 100 and the case 200. When viewed from the first direction D1, the pair of protrusions 214 is provided inside the projection 213 and formed to face each other in the second direction D2 with the opening 211 interposed therebetween. The pair of protrusions 214 extends, for example, in a cylindrical shape from the second surface 201b toward the light incident surface 102a.

The recess 215 is formed in the first surface 201a of the top plate 201. The recess 215 is formed in a cylindrical shape. The recess 215 has an annular bottom surface 215a. The opening 211 is formed in this bottom surface 215a. A wavelength selection filter (not illustrated), which is disposed on the bottom surface 215a while covering the opening 211, is accommodated inside the recess 215. The filter is used to remove, for example, second-order diffracted light generated by the diffraction grating 23, and may have a structure in which a plurality of types of wavelength selection filters is arranged so that unnecessary second-order diffracted light can be removed for each channel ch described later.

The side wall 202 is formed in a cylindrical shape having a central axis along the first direction D1. The side wall 202 extends from the second surface 201b of the top plate 201 toward the opposite side from the first surface 201a. The cover member 203 is attached to an end 202a of the side wall 202 opposite to the top plate 201.

The cover member 203 is formed, for example, in a circular ring plate shape having an opening. The cover member 203 is fixed to the end 202a of the side wall 202 by a cover fixing member such as a screw. The top plate 201, the side wall 202, and the cover member 203 described above are formed, for example, from an insulating light-shielding material, such as black resin, to constitute the insulating and light-shielding case 200. Further, the case 200 holds the electron tube 100 by interposing the electron tube 100 in the first direction D1 between the cover member 203 and the top plate 201.

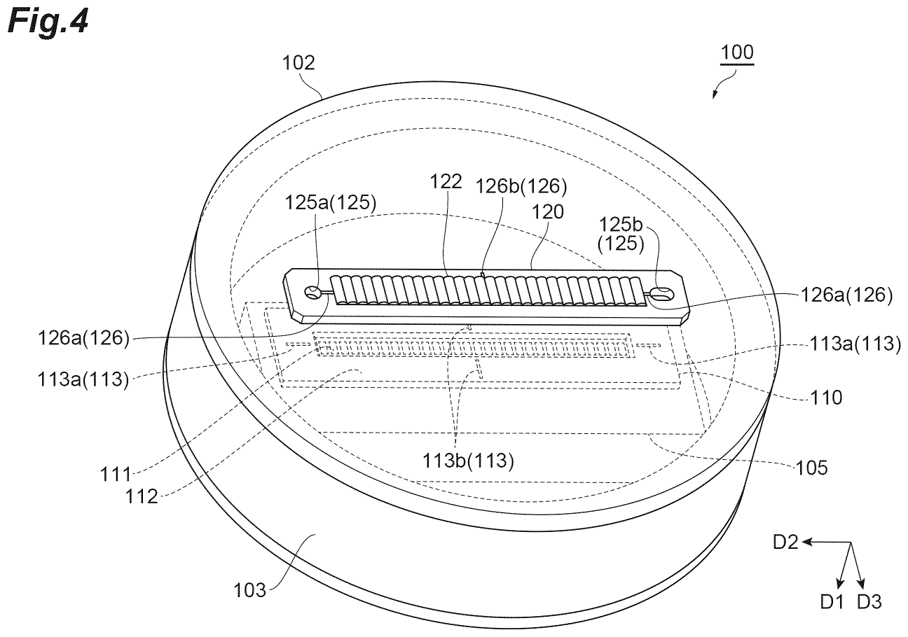

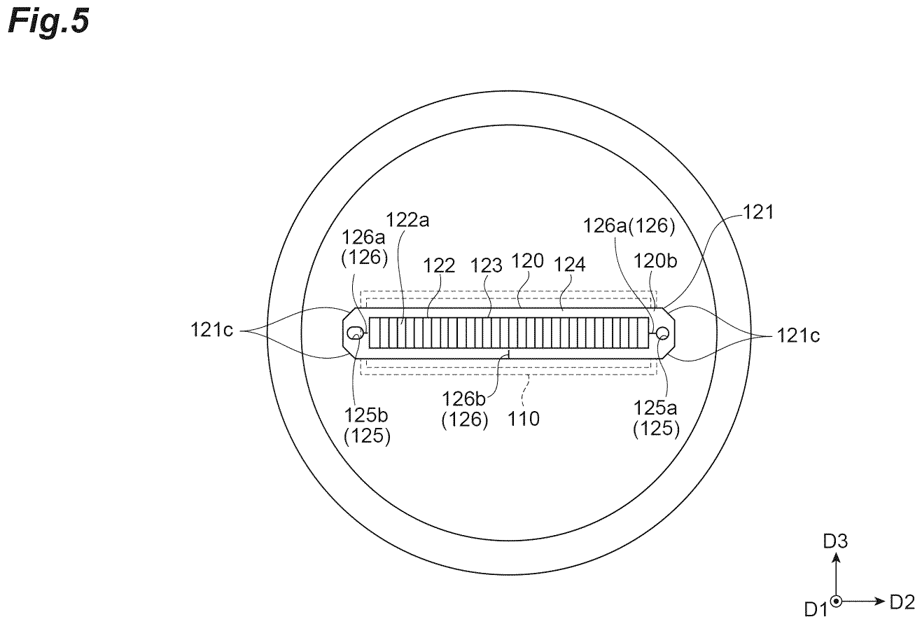

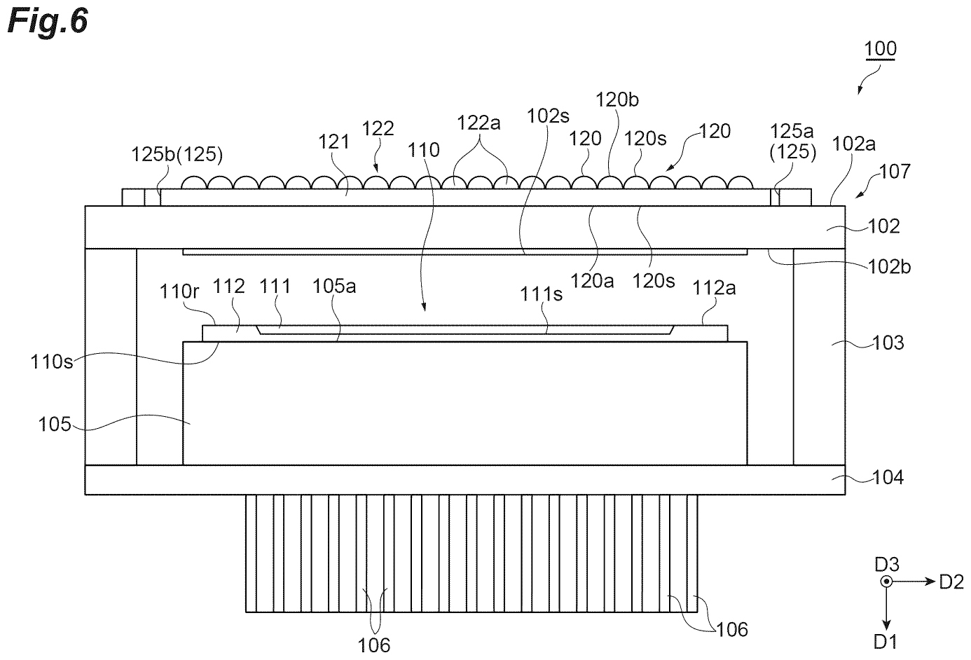

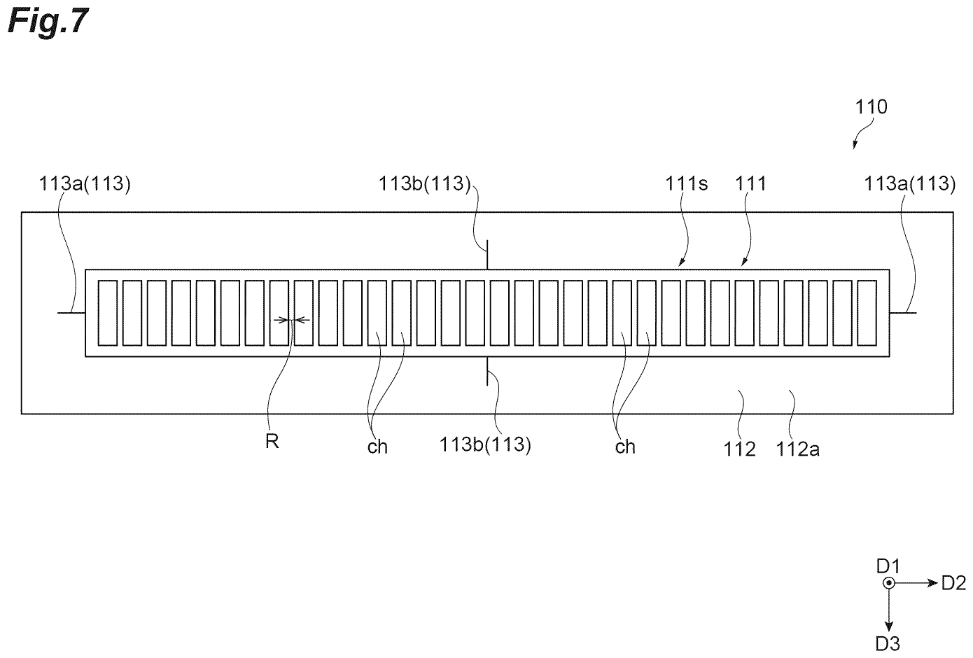

A configuration of the electron tube 100 will be described with reference to FIGS. 4 to 7. FIG. 4 is a perspective view of the electron tube 100. FIG. 5 is a plan view of the electron tube 100. FIG. 6 is a schematic cross-section view of the electron tube 100. FIG. 7 is a schematic plan view of an electron multiplier portion.

The electron tube 100 includes a light incident window 102, a photoelectric conversion portion 102s, a side tube 103, a stem 104, a base member 105, a pin 106, an electron multiplier portion 110, and the positioning member 120. The light incident window 102, the side tube 103, and the stem 104 form a housing 107. The light incident window 102 includes the light incident surface 102a and a rear surface 102b on the opposite side from the light incident surface 102a. The light incident window 102 is made of a light-transmitting material such as glass, and transmits light incident from the light incident surface 102a toward the rear surface 102b. The light incident window 102 is formed, for example, in a circular flat plate shape (for example, a disc shape).

The photoelectric conversion portion 102s is provided on the rear surface 102b of the light incident window 102 serving as a substrate. That is, the photoelectric conversion portion 102s is disposed inside the housing 107 to face the light incident window 102. The photoelectric conversion portion 102s includes a photoelectric conversion layer made of a thin film of a compound semiconductor such as GaAs, and emits photoelectrons in response to the light L2 incident from the light incident window 102. The photoelectric conversion portion 102s may be a so-called alkaline photocathode. The photoelectric conversion portion 102s is, for example, a transmissive photocathode.

The side tube 103 is formed in a tubular shape (here, circular tube shape) with both ends open, for example, from an insulating material such as ceramic. One end of the side tube 103 is sealed by the light incident window 102. The stem 104 is formed in a plate shape (here, disc shape) from an insulating material such as ceramic, and seals the other end of the side tube 103. In this way, a vacuum region can be formed in the side tube 103. In this embodiment, for example, a voltage can be applied to the photoelectric conversion portion 102s so that the stem 104 side is at a GND potential (so that the photoelectric conversion portion 102s is at a negative potential and the stem 104 side is at ground potential) (see FIG. 2).

The base member 105 is provided on the stem 104 so as to be located inside the side tube 103. The base member 105 has a top surface 105a that is a surface facing the photoelectric conversion portion 102s, and is formed using an insulating material such as ceramic in a rectangular parallelepiped block shape that protrudes convexly from the stem 104 toward the photoelectric conversion portion 102s. A plurality of pins 106 (for example, the same number as the number of channels ch described below) is provided through the base member 105 so that each of the pins can output an electrical signal detected by the electron multiplier portion 110 to the outside. For example, one end of the pin 106 reaches a surface (top surface 105a) of the base member 105 on the opposite side from the stem 104, and the other end of the pin 106 protrudes from a surface of the base member 105 on the stem 104 side to the outside of the side tube 103. Note that base member 105 may be formed integrally with the stem 104, and the pin 106 and the electron multiplier portion 110 may be electrically connected via another conductive member such as a wire.

The electron multiplier portion 110 multiplies electrons emitted from the photoelectric conversion portion 102s. The electron multiplier portion 110 is, for example, a semiconductor element. The electron multiplier portion 110 is disposed inside the housing 107. The electron multiplier portion 110 is disposed on the top surface 105a of the base member 105 to face the photoelectric conversion portion 102s along the first direction D1. More specifically, the electron multiplier portion 110 includes a rear surface 110r and a surface 110s, and the rear surface 110r (that is, an electron incident surface 111s described later) is provided on the top surface 105a of the base member 105 to face the photoelectric conversion portion 102s (so that the surface 110s faces the top surface 105a side of the base member 105).

The electron multiplier portion 110 is electrically connected to the pin 106 by, for example, bump connection. The electron multiplier portion 110 is, for example, an AD (Avalanche Diode). The electron multiplier portion 110 receives photoelectrons from the photoelectric conversion portion 102s, causes multiplication by electron input, and causes further multiplication by avalanche multiplication. In addition, in this embodiment, the electron multiplier portion 110 uses a rear surface illumination type semiconductor element.

The electron multiplier portion 110 has a first portion 111 and a second portion 112. The first portion 111 has the electron incident surface 111s, which is a surface facing the photoelectric conversion portion 102s. The electron incident surface 111s includes a plurality of channels ch arranged at a distance from each other along the second direction D2 intersecting with the first direction D1. In other words, the electron incident surface 111s is a photoelectron detection surface in the electron multiplier portion 110, and includes a sensitive region which is the plurality of channels ch and an insensitive region R formed between the respective channels ch. The electron multiplier portion 110 multiplies (detects) photoelectrons in each of the plurality of channels ch. That is, the plurality of channels ch multiplies each of the electrons emitted from the photoelectric conversion portion 102s in response to each of a plurality of beams of the light L2 incident from the photoelectric conversion portion 102s. Note that, in this embodiment, the electron multiplier portion 110 is a so-called one-dimensional sensor (line sensor) in which the plurality of channels is arranged in a row. However, the electron multiplier portion 110 may also be a so-called two-dimensional sensor (area sensor) in which the plurality of channels is arranged in a plurality of rows.

The second portion 112 is provided at least on both end sides of the electron incident surface 111s in the second direction D2. In this embodiment, the second portion 112 is formed in a rectangular frame shape to surround the electron incident surface 111s when viewed from the first direction D1. The second portion 112 is formed thicker than the first portion 111 by protruding toward the photoelectric conversion portion 102s side beyond the electron incident surface 111s. A potential is applied between the photoelectric conversion portion 102s and the electron incident surface 111s such that photoelectrons emitted from the photoelectric conversion portion 102s move toward the electron incident surface 111s at desired acceleration. In this embodiment, a voltage is applied so that the electron incident surface 111s side is at GND potential (so that the photoelectric conversion portion 102s is at a negative potential and the electron incident surface 111s side is at ground potential).

The second portion 112 has a surface 112a which faces the photoelectric conversion portion 102s. The second portion 112 has a plurality of first reference lines (markers) 113 formed on the surface 112a. The plurality of first reference lines 113 is so-called alignment lines, and may be visually identifiable physical structures such as metal films, grooves, or protrusions. The plurality of first reference lines 113 serve as a reference for aligning the positioning member 120, which will be described later.

The plurality of first reference lines 113 includes a pair of first lines 113a and a pair of second lines 113b, which are disposed at a center of the first portion 111 in a short direction (third direction D3) and a center of the first portion 111 in a longitudinal direction (second direction D2), respectively. The pair of first lines 113a is straight lines along the second direction D2 formed on the surface 112a. The pair of first lines 113a is formed on both sides of the second portion 112 in the second direction D2 to face each other via the first portion 111. In other words, the pair of first lines 113a is straight lines extending from both ends of the first portion 111 in the second direction D2 toward the outside in the second direction D2.

The pair of second lines 113b is straight lines along the third direction D3 formed on the surface 112a. The pair of second lines 113b is formed on both sides of the second portion 112 in the third direction D3 to face each other via the first portion 111. In other words, the pair of second lines 113b is straight lines extending outward in the third direction D3 from both ends of the first portion 111 in the third direction D3.

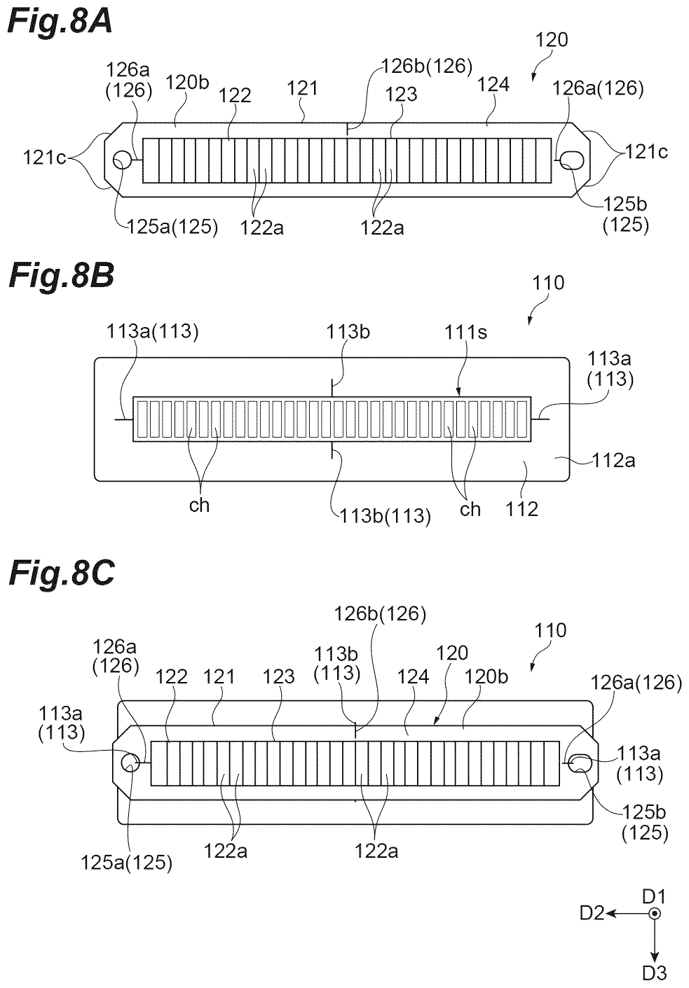

FIGS. 8A to 8C are views of the electron multiplier portion 110 and the positioning member 120 viewed from above the light incident surface 102a. FIG. 8A is a view illustrating only the positioning member 120. FIG. 8B is a view illustrating only the electron multiplier portion 110. FIG. 8C is a view illustrating a state in which the positioning member 120 is disposed on the electron multiplier portion 110.

The positioning member 120 will be described with reference to FIGS. 6 and 8A to 8C. The positioning member 120 is formed as a rectangular member whose longitudinal direction is the second direction D2 using a light-transmitting material, such as a light-transmitting resin or glass, separately from the light incident window 102, and is fixed (for example, glued) to the light incident surface 102a of the light incident window 102. The positioning member 120 is fixed to the light incident surface 102a so that a light passing portion 123 faces the photoelectric conversion portion 102s and the light L2 passing through the light passing portion 123 is incident on a desired region of the photoelectric conversion portion 102s. The positioning member 120 is formed in a plate shape. The positioning member 120 has a first surface 120a on the light incident surface 102a side and a second surface 120b on the opposite side from the first surface 120a.

An anti-reflection film (anti-reflection coating) 120s is formed on at least one of the first surface 120a and the second surface 120b of the positioning member 120. In this embodiment, the anti-reflection film 120s is formed on both the first surface 120a and the second surface 120b. Thus, the positioning member 120 is disposed such that the first surface 120a faces the light incident surface 102a, and is fixed to the light incident surface 102a via the anti-reflection film 120s.

The positioning member 120 has a plate-shaped portion 121 and a cylindrical lens array (optical element) 122. The plate-shaped portion 121 is formed in a rectangular shape whose longitudinal direction is the second direction D2. The plate-shaped portion 121 includes the second surface 120b. A corner 121c of the plate-shaped portion 121 is chamfered, for example, in a C-shape. The plate-shaped portion 121 has the light passing portion 123, a frame 124, a reference portion 125, and a plurality of second reference lines (markers) 126.

The light passing portion 123 is formed at a center of the plate-shaped portion 121 when viewed from the first direction D1. The light passing portion 123 is formed in a rectangular shape whose longitudinal direction is the second direction D2. The light passing portion 123 passes the light L2 from the spectroscopic unit 2 toward the light incident surface 102a of the light incident window 102. The positioning member 120 and the light passing portion 123 are disposed to overlap the electron multiplier portion 110 when viewed from the first direction D1.

When viewed from the first direction D1, the frame 124 is formed in a rectangular frame shape to surround the light passing portion 123. Note that the frame 124 does not necessarily need to have a light-transmitting property, and may be formed of a light-shielding material separate from the light passing portion 123.

The reference portion 125 is formed in the frame 124. The reference portion 125 serves as a reference for mechanical positioning with respect to the spectroscopic unit 2. The reference portion 125 has a first through-hole 125a and a second through-hole 125b. The first through-hole 125a is formed at one end of the frame 124 in the second direction D2. The first through-hole 125a is a through-hole along the first direction D1. The first through-hole 125a is formed, for example, in a perfect circle shape when viewed from the first direction D1. The first through-hole 125a is a mechanical structure and is a position reference that serves as a reference for a position with respect to the spectroscopic unit 2. That is, the first through-hole 125a provides a mechanical position reference by inserting a protrusion, for example, a protrusion having a circular cross section, that fits into an inner wall surface of the first through-hole 125a.

The second through-hole 125b is formed at the other end of the frame 124 in the second direction D2. The second through-hole 125b is a through-hole along the first direction D1. The second through-hole 125b is an elliptical long hole whose longitudinal direction is the second direction D2 when viewed from the first direction D1. The second through-hole 125b is a mechanical structure and an angle reference that serves as a reference for an angle with respect to the spectroscopic unit 2. In other words, the second through-hole 125b provides an angle reference that allows mechanical angle adjustment while restricting rotation of the positioning member 120 together with the first through-hole 125a by inserting a protrusion having mobility inside the second through-hole 125b at a position different from the first through-hole 125a.

The plurality of second reference lines 126 is formed on the second surface 120b as illustrated in FIG. 8A. The plurality of second reference lines 126 includes a pair of first lines 126a and a second line 126b, which are disposed at a center of the light passing portion 123 in the short direction (third direction D3) and a center of the light passing portion 123 in the longitudinal direction (second direction D2), respectively. The plurality of second reference lines 126 is so-called alignment lines used when positioning the positioning member 120 with respect to the electron multiplier portion 110, and may be visually identifiable physical structures such as metal films, grooves, or protrusions. Furthermore, the plurality of first reference lines 113 may be formed in the light incident window 102 serving as a substrate on which the photoelectric conversion portion 102s is formed. That is, a marker (the plurality of first reference lines 113 or the plurality of second reference lines 126) is formed in at least one of the positioning member 120, the light incident window 102 (substrate) on which the photoelectric conversion portion 102s is provided, and the electron multiplier portion 110.

The pair of first lines 126a is straight lines formed along the second direction D2 on the second surface 120b. The pair of first lines 126a is formed on both sides of the frame 124 in the second direction D2 to face each other via the light passing portion 123. In other words, the pair of first lines 126a is straight lines extending outward in the second direction D2 from both ends of the light passing portion 123 in the second direction D2.

The second line 126b is a straight line formed along the third direction D3 on the second surface 120b. The second line 126b is formed on one side of the light passing portion 123 in the third direction D3. In other words, the second line 126b is a straight line extending from one end of the light passing portion 123 in the third direction D3 toward the outside in the third direction D3.

Here, a description will be given of a procedure for positioning the electron multiplier portion 110 and the positioning member 120 with reference to FIGS. 8A to 8C. First, as illustrated in FIG. 8A, the positioning member 120 is prepared. Next, as illustrated in FIG. 8B, it is confirmed that the electron multiplier portion 110 can be visually recognized. Next, as illustrated in FIG. 8C, the positioning member 120 is fixed to the light incident surface 102a so that the first line 113a of the electron multiplier portion 110 and the first line 126a of the positioning member 120 coincide with each other, and so that the second line 113b of the electron multiplier portion 110 and the second line 126b of the positioning member 120 coincide with each other. In this way, the positioning member 120 is positioned at the electron multiplier portion 110.

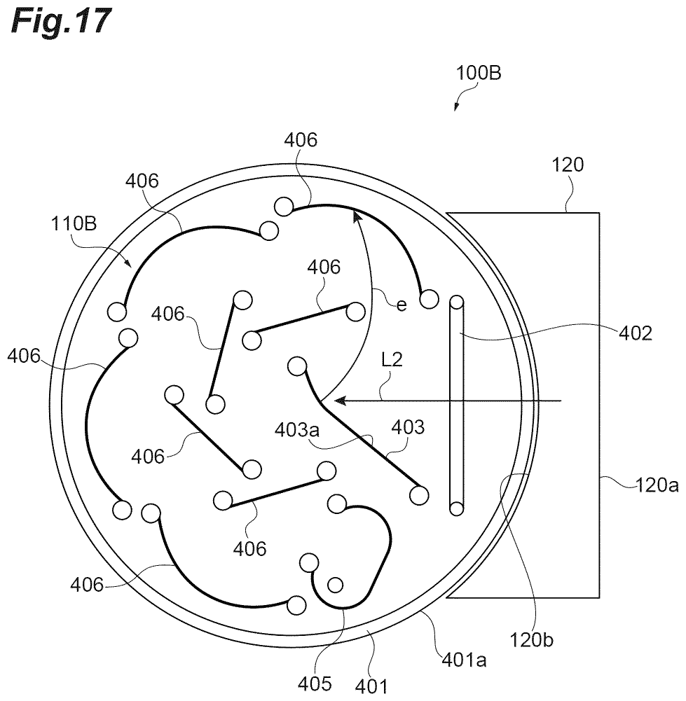

Note that the positioning member 120 is originally positioned and fixed to the light incident window 102 so that light from an external device (the light L2 having the plurality of wavelengths in this embodiment) is appropriately incident on a desired region of the photoelectric conversion portion 102s. However, since the photoelectric conversion portion 102s is made of a thin film, it is difficult to provide a reference line (marker) on the photoelectric conversion portion 102s itself. Therefore, in the case of the transmissive photoelectric conversion portion 102s (transmissive photocathode) such as the electron tube 100 of this embodiment, it is also possible to position the positioning member 120 by providing a reference line on the light incident window 102, which is a substrate on which the photoelectric conversion portion 102s is formed. However, when a reference line is provided on the light incident window 102 serving as a light incident surface and a light exit surface, the reference line may become an obstacle during light detection. For this reason, in this embodiment, a reference line is provided on the electron multiplier portion 110. In the case of the transmissive photocathode, photoelectrons emitted from the photoelectric conversion portion 102s are basically directed toward the electron multiplier portion 110 in a projective positional relationship, so that by performing appropriate positioning with respect to the electron multiplier portion 110, positioning with respect to the photoelectric conversion portion 102s becomes also appropriate. Furthermore, in this embodiment, the reference line is provided in the second portion 112 of the electron multiplier portion 110, that is, in a region other than the electron incident surface 111s, so that the reference line does not become an obstacle to electron multiplication. Note that, in the case of an electron tube 100B including a reflective photocathode illustrated in FIG. 17, rather than the transmissive photoelectric conversion portion 102s such as the electron tube 100 of this embodiment, even when a reference line is provided on the substrate on which the photocathode is formed, the reference line does not become an obstacle during light detection, and the positioning member 120 can be appropriately positioned.

As illustrated in FIGS. 6 to 9, the cylindrical lens array 122 is disposed on a surface of the light passing portion 123 and includes the second surface 120b. The cylindrical lens array 122 receives incidence of the light L2 from the spectroscopic unit 2 and emits the light L2 toward the light incident surface 102a.

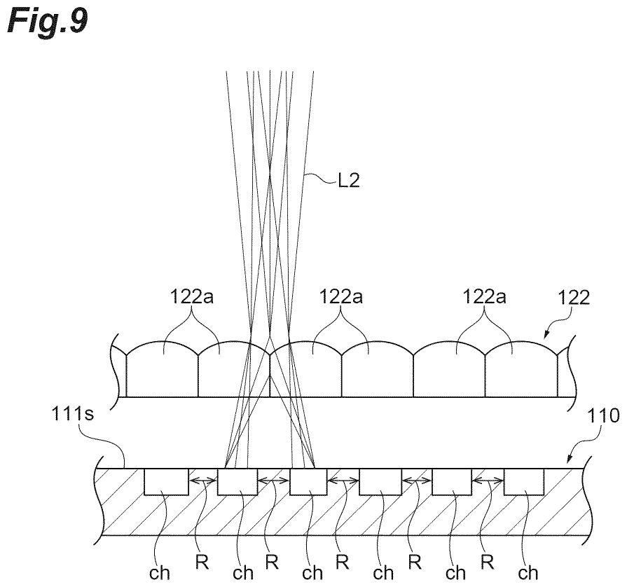

The cylindrical lens array 122 includes a plurality of cylindrical lenses (optical structures) 122a. The plurality of cylindrical lenses 122a is arranged along the second direction D2. Each of the plurality of cylindrical lenses 122a has a curvature in a plane along the second direction D2. Each of the cylindrical lenses 122a is arranged to be convex toward an opposite side from the light incident surface 102a of the light incident window 102. The plurality of cylindrical lenses 122a is aligned with the plurality of channels ch, respectively. Specifically, as illustrated in FIG. 9, the cylindrical lenses 122a are aligned so that each of beams of the light L2 emitted from the plurality of cylindrical lenses 122a is incident on each of the plurality of channels ch of the corresponding electron multiplier portion 110. That is, the cylindrical lenses 122a are aligned so that the light L2 is not incident on the insensitive region R of the electron multiplier portion. In this way, it is possible to allow light to be efficiently incident on each of the plurality of channels ch.

Note that the cylindrical lenses 122a may be arranged at equal or unequal pitches along the second direction D2. When the cylindrical lenses 122a are arranged at unequal pitches, arrangement of the cylindrical lenses 122a can be set as follows. That is, when a principal ray of the light L2 is incident on the cylindrical lenses 122a at an incident angle θ, a center of the cylindrical lenses 122a may be shifted by f·tan θ from a center of the channels ch of the electron multiplier portion 110 (f is a focal length). When the light L2 is imaged by a non-telecentric optical system, an angle of the principal ray on an image surface varies depending on the field of view, and thus as a result, it is advantageous to arrange the cylindrical lenses 122a at unequal pitches. Further, in this case, an optical system for imaging the light L2 is not limited to image-side telecentric arrangement. Therefore, it is possible to avoid restrictions on arrangement of the optical system, such as fixing a distance between the diffraction grating 23 and the imaging lens 24 to achieve image-side telecentric arrangement and increasing the size of the lens. Note that, in this embodiment, the cylindrical lens array 122 (cylindrical lenses 122a) is molded integrally with the plate-shaped portion 121. However, the cylindrical lens array 122 may a separate body. In this case, the cylindrical lens array 122 (cylindrical lenses 122a) may be fixed onto the light passing portion 123 made of a light-transmitting member on a flat plate, or the cylindrical lens array 122 (cylindrical lenses 122a) may be fixed to be fit into the light passing portion 123 formed as an opening.

The electron tube 100 configured as described above is mechanically positioned with respect to the case 200 by being clamped between the top plate 201 and the cover member 203 of the case 200 while the pair of protrusions 214 of the case 200 is inserted into the first through-hole 125a and the second through-hole 125b of the positioning member 120, respectively. Then, the case 200 is mechanically positioned and fixed to the spectroscopic unit 2 by inserting the positioning pins 12c of the attachment portion 12 of the spectroscopic unit 2 into the plurality of through-holes 212 of the case 200, respectively. As a result, the electron tube 100 is mechanically positioned with respect to the spectroscopic unit 2. That is, the electron tube 100 is mechanically positioned with respect to the spectroscopic unit 2 using the positioning member 120 via the case 200. In this instance, inside the electron tube 100, the positioning member 120 is positioned with respect to the electron multiplier portion 110, which is an internal structure of the housing 107, and therefore positioning of the spectroscopic unit 2 and the electron multiplier portion 110 is also achieved.

As described above, the electron tube 100 includes the housing 107 including the light incident window 102, the photoelectric conversion portion 102s and the electron multiplier portion 110 disposed inside the housing 107, and the positioning member 120 fixed to the light incident surface 102a of the light incident window 102. Further, the positioning member 120 has the reference portion 125 serving as a reference for mechanical positioning with respect to the spectroscopic unit 2. The positioning member 120 is configured separately from the light incident window 102 and is fixed to the light incident window 102. Therefore, after the positioning member 120 is completed as the electron tube 100 (after a manufacturing process for the electron tube 100 is completed), that is, after any changes in mechanical precision due to influences related to manufacture of the electron tube 100 are determined, the positioning member 120 can be fixed to the light incident window 102 in a desired state. For this reason, the reference portion 125 of the positioning member 120 is not easily affected by distortion during, for example, a heating process, etc. for sealing the housing 107 (the light incident window 102) associated with manufacturing of the electron tube 100. Therefore, when attaching the electron tube 100 to the spectroscopic unit 2, by using the reference portion 125 of the positioning member 120, it is possible to perform high-precision positioning according to mechanical precision of the reference portion 125. Therefore, according to the electron tube 100, it is possible to easily and highly precisely perform positioning with respect to the spectroscopic unit 2.

The positioning member 120 is fixed to the light incident surface 102a so that the light passing portion 123 faces the photoelectric conversion portion 102s and the light L2 passing through the light passing portion 123 is incident on a desired region of the photoelectric conversion portion 102s. In this way, it is possible to perform high-precision positioning so that the light L2 from the spectroscopic unit 2 is guided to an appropriate region of the photoelectric conversion portion 102s.

A marker is formed on at least one of the positioning member 120, the light incident window 102 in which the photoelectric conversion portion 102s is provided, and the electron multiplier portion 110. In this way, it is possible to perform high-precision positioning using the marker.

The electron multiplier portion 110 has the plurality of channels ch. When the electron multiplier portion 110 is multiple channels having the plurality of channels ch, light dispersed by the spectroscopic unit 2 needs to be incident on the channels ch corresponding to the respective wavelengths, and therefore more precise positioning is required. Even in such a case, it is possible to enable easy and highly precise positioning with respect to the spectroscopic unit 2.

The reference portion 125 has the first through-hole 125a serving as a reference for a position with respect to the spectroscopic unit 2, and the second through-hole 125b serving as a reference for an angle with respect to the spectroscopic unit 2. In this way, it is possible to easily and highly precisely determine the position and the angle with respect to the spectroscopic unit 2.

The anti-reflection film 120s is formed on at least one of the first surface 120a and the second surface 120b of the positioning member 120. In this way, it is possible to reduce light reflection on the positioning member 120.

The cylindrical lens array 122 is provided on a surface of the light passing portion 123. The cylindrical lens array 122 receives the light L2 from the spectroscopic unit 2 and emits the light L2 toward the light incident surface 102a. The plurality of cylindrical lenses 122a of the cylindrical lens array 122 is aligned with the channels ch, respectively. In this way, as described above, it is possible to allow the light L2 to be efficiently incident on each of the plurality of channels ch of the electron multiplier portion.

The spectroscope 1 includes the spectroscopic unit 2 for dispersing the detection light L1 into the light L2 having the plurality of wavelengths and emitting the light L2, and the electron tube 100. In this way, it is possible to easily and highly precisely position the electron tube 100 with respect to the spectroscopic unit 2.

The spectroscope 1 includes the filter 22. The filter 22 is disposed at a previous stage of the diffraction grating 23 on the optical path of the detection light L1, and reflects or absorbs light of a specific wavelength band of the detection light L1.

In this way, it becomes possible for the filter 22 to reflect or absorb light serving as noise with respect to the detection light L1.

The above embodiment describes one aspect of the disclosure. Therefore, the disclosure is not limited to the above-described spectroscope 1, and may be arbitrarily modified. Next, modified examples will be described.

The electron multiplier portion 110 of the electron tube 100 does not need to have the plurality of first reference lines 113. In this case, for example, to position the positioning member 120 and the electron multiplier portion 110, a pattern of a semiconductor element which is the electron multiplier portion 110 can be used in place of the first reference lines 113. One example of the pattern of the semiconductor element is a pattern of the plurality of channels ch of the electron incident surface 111s (for example, lines formed on outer edges of the respective channels).

Furthermore, the positioning member 120 does not have to have the plurality of second reference lines 126. In this case, any structure of the positioning member 120 (such as the cylindrical lens array 122) or the reference portion 125 can be used in place of the plurality of second reference lines 126 to position the positioning member 120 and the electron multiplier portion 110.

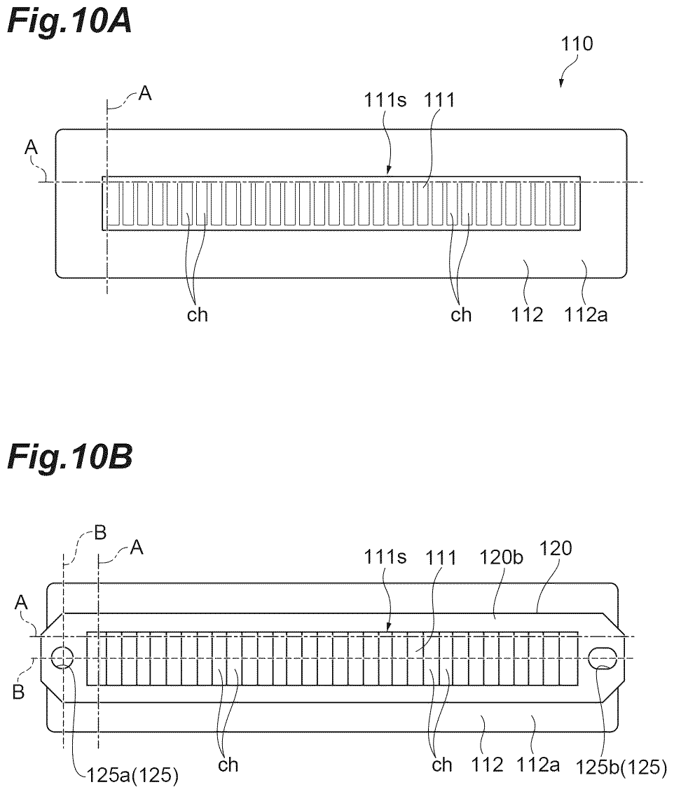

FIGS. 10A and 10B is drawings for describing a positioning method not using the first reference lines 113 and the second reference lines 126. First, as illustrated in FIG. 10A, the electron multiplier portion 110 is observed by a camera from above the light incident surface 102a. Next, any position of the pattern of the plurality of channels ch formed on the electron incident surface 111s of the electron multiplier portion 110 is set as a reference, and the reference is aligned with two orthogonal electron lines A displayed on the camera. Next, as illustrated in FIG. 10B, the positioning member 120 is disposed on the light incident surface 102a. Next, two orthogonal electronic lines B, separate from the electronic lines A, are displayed on the camera at a position where the reference portion 125 (the first through-hole 125a and the second through-hole 125b) of the positioning member 120 is disposed in design. Then, the positioning member 120 is adjusted and fixed onto the light incident surface 102a so that a distance between each of the electronic lines A and each of the electronic lines B is an ideal distance in design and the reference portion 125 is aligned with the electronic line B (for example, so that an intersection of the electronic lines B is located at a center of the first through-hole 125a).

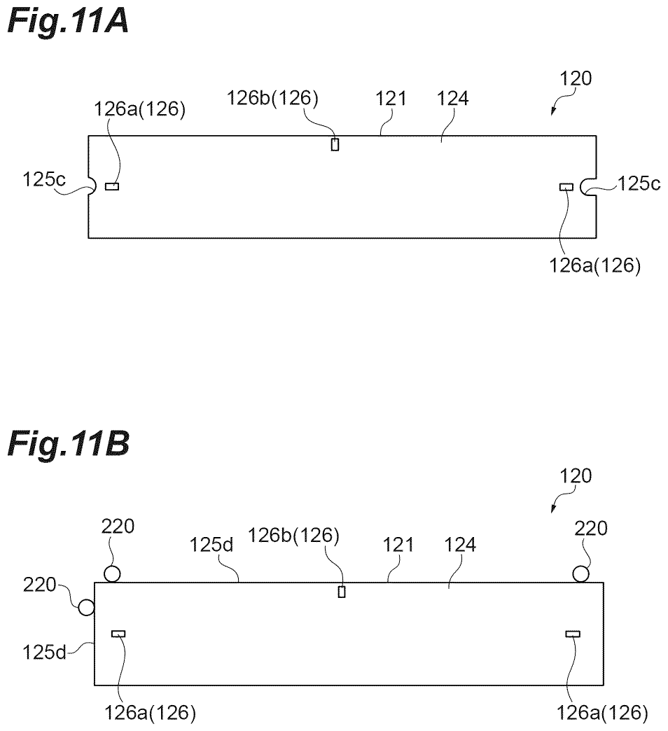

In the above embodiment, the reference portion 125 has the first through-hole 125a and the second through-hole 125b. However, the reference portion 125 is not limited to a hole and may include at least one of a protrusion, a notch, and an end surface. For example, the reference portion 125 may be a notch 125c formed at an outer edge of the frame 124 as illustrated in FIG. 11A. In this case, for example, the electron tube 100 can be mechanically positioned with respect to the spectroscopic unit 2 by inserting a protrusion 214 formed on the top plate 201 of the case 200 into the notch 125c (by abutting the protrusion 214 against an inner surface of the notch 125c).

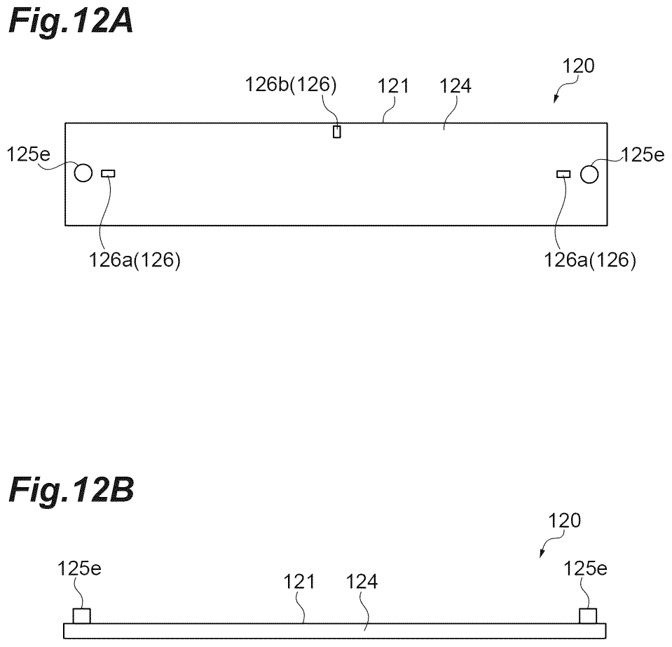

Furthermore, the reference portion 125 may be an end surface 125d facing the outside of the frame 124 as illustrated in FIG. 11B. In this case, for example, by abutting a protrusion 220 (for example, a pin) formed on the top plate 201 against the end surface 125d, the electron tube 100 can be mechanically positioned with respect to the spectroscopic unit 2. Furthermore, the reference portion 125 may include a protrusion 125e as illustrated in FIGS. 12A and 12B. In this case, for example, a hole is formed in the top plate 201, and the electron tube 100 can be mechanically positioned with respect to the spectroscopic unit 2 by inserting the protrusion 125e into the hole. In either case, the electron tube 100 can be positioned with high precision. Note that the cylindrical lens array 122 and the light passing portion 123 are omitted in FIGS. 11A, 11B, 12A and 12B.

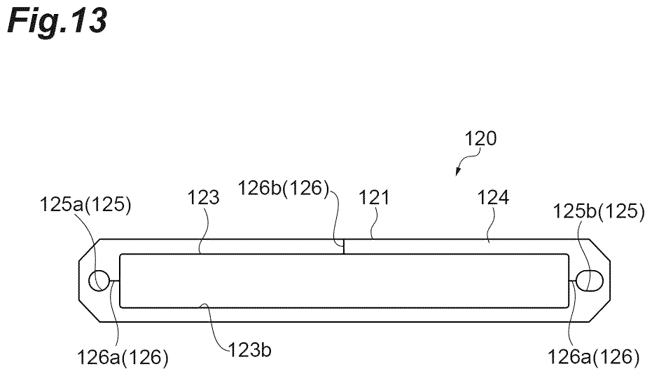

In addition, as illustrated in FIG. 13, an opening 123b that exposes the light incident surface 102a of the light incident window 102 to the outside may be formed in the light passing portion 123. That is, the opening 123b serving as a gap may be formed in the light passing portion 123 by removing a light-transmitting material included in the light passing portion 123 in a region through which the light L2 passes in the light passing portion 123. In this case, the light L2 from the spectroscopic unit 2 can be made incident on the light incident surface 102a without undergoing reflection, refraction, etc. at the positioning member 120.

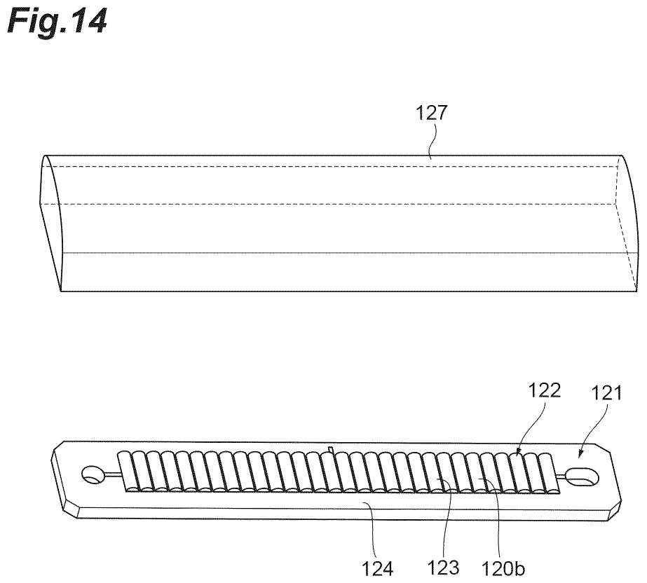

As illustrated in FIG. 14, the positioning member 120 may further include a lens (light-converging element) 127. In the illustrated example, the lens 127 is provided, for example, on the second surface 120b of the cylindrical lens array 122. Here, the lens 127 is, for example, a cylindrical lens having a curvature (having a light-converging structure) in a plane intersecting the second direction D2, which is an arrangement direction of the channels ch (that is, in a plane intersecting a plane in which the cylindrical lens 122a has a curvature). In other words, the lens 127 is a light-converging lens having refractive power in the plane intersecting the second direction D2, which is the arrangement direction of the channels ch. The lens 127 is disposed to be convex toward the opposite side from the light incident surface 102a of the light incident window 102 (convex toward a light incident side of the lens 127). In this case, it is possible to widen a field of view in the plane intersecting the arrangement direction of the channels. Note that the lens 127 may be disposed to be convex toward the light incident surface 102a side of the light incident window 102 (convex toward a light exit side of the lens 127), or may be shaped to be convex toward both the opposite side from the light incident surface 102a of the light incident window 102 and the light incident surface 102a side of the light incident window 102 (convex toward both the light incident side and the light exit side of the lens 127).

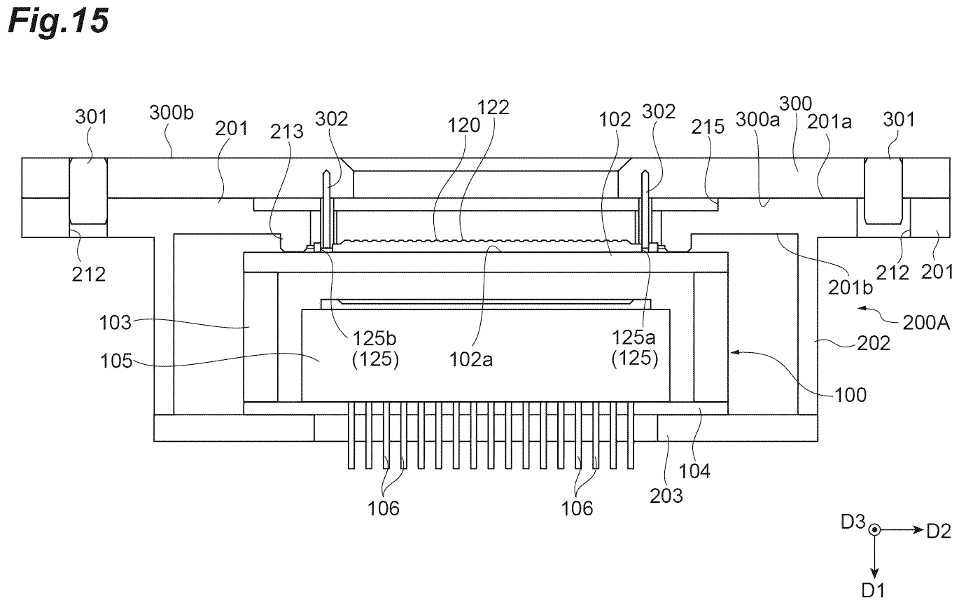

Furthermore, as illustrated in FIG. 15, the spectroscope 1 may have a case 200A instead of the case 200. The case 200A differs from the case 200 of the above-mentioned embodiment in that the case 200A does not have the protrusion 214. When such a case 200A is used, the electron tube 100 can be easily and highly precisely positioned with reference to the spectroscopic unit 2 by using an assembly jig 300. Positioning using the assembly jig 300 will be described below.

The assembly jig 300 is formed in a plate shape having a first surface 300a and a second surface 300b on the opposite side from the first surface 300a. The assembly jig 300 is disposed so that the first surface 300a faces (is in contact with) the first surface 201a of the top plate 201.

In this state, pins 301 provided through the assembly jig 300 are inserted into the through-holes 212 of the top plate 201, and other pins 302 provided through the assembly jig 300 are inserted into the first through-hole 125a and the second through-hole 125b of the positioning member 120 via the top plate 201, whereby the electron tube 100, the case 200A, and the assembly jig 300 are mechanically positioned with respect to each other. Note that fixing and positioning with respect to the spectroscopic unit 2 are the same as those for the case 200 in the above-mentioned embodiment. Therefore, by using the assembly jig 300, it is possible to easily and highly precisely position the electron tube 100 with respect to the spectroscopic unit 2.

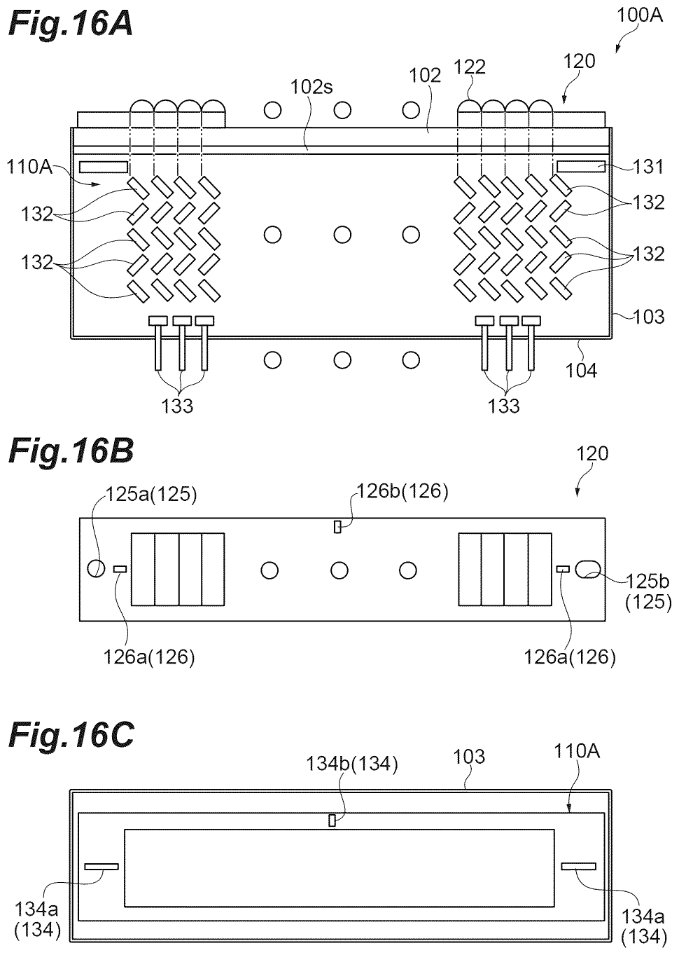

Here, in the above embodiment, the electron tube 100 having the electron multiplier portion 110 including the semiconductor element such as the HPD has been illustrated. However, the electron tube may be a photomultiplier tube. FIG. 16A is a schematic view illustrating an electron tube 100A which is a photomultiplier tube. The electron tube 100A illustrated in FIG. 16A is a photomultiplier tube having multiple channels (multichannel PMT). The electron tube 100A has an electron multiplier portion 110A, and the electron multiplier portion 110A in this embodiment has a focusing electrode 131, a plurality of dynodes 132, and a plurality of anode electrodes 133.

The focusing electrode 131 focuses photoelectrons emitted from the photoelectric conversion portion 102s toward the dynodes 132. The focusing electrode 131 is disposed to face the photoelectric conversion portion 102s.

The plurality of dynodes 132 is provided between the focusing electrode 131 and the plurality of anode electrodes 133. The plurality of dynodes 132 emits secondary electrons in response to incidence of photoelectrons focused by the focusing electrode 131, and multiplies the secondary electrons. The plurality of dynodes 132 is disposed in multiple stages between the focusing electrode 131 and the plurality of anode electrodes 133, and forms one channel ch. That is, the electron multiplier portion 110A is configured by arranging a plurality of channels ch, each of which is configured by disposing a plurality of dynodes in multiple stages, along the second direction D2. Even in this case, the electron multiplier portion 110A has a plurality of channels ch arranged in one direction for multiplying each of the electrons emitted from the photoelectric conversion portion 102s in response to each beam of the plurality of beams of the light L2 incident from the light incident window 102.

As illustrated in FIGS. 16B and 16C, even in this case, the positioning member 120 can be configured similarly to the above embodiment. A plurality of first reference lines 134 (markers) serving as a reference for positioning of the positioning member 120 is drawn on the electron multiplier portion 110A (specifically, the focusing electrode 131 in this embodiment). The second reference lines 126 of the positioning member 120 are aligned with the first reference lines 134. Therefore, even the electron tube 100A, which is a photomultiplier tube, can be positioned easily and highly precisely, similarly to the electron tube 100. Specifically, by attaching the reference portion 125 of the positioning member 120 to the spectroscopic unit 2 as a mechanical reference, the spectroscopic unit 2 and the electron tube 100A (and further an internal structure of the electron multiplier portion 110A, etc.) can be highly precisely positioned.

Further, as illustrated in FIG. 17, the electron tube may be an electron tube 100B, which is a side-incident photomultiplier tube. The electron tube 100B is a photomultiplier tube having a reflective photocathode. The electron tube 100B has a bulb 401, a grid 402, a photoelectric conversion portion 403, a plurality of dynodes 406 (electron multiplier portion 110B), and an anode 405.

The bulb 401 accommodates the grid 402, the photoelectric conversion portion 403, the plurality of dynodes 406 (the electron multiplier portion 110B), and the anode 405. The light L2 is incident into the bulb 401 from a side surface 401a of the bulb 401 and provided to the photoelectric conversion portion 403. That is, a portion of the bulb 401 facing the photoelectric conversion portion 403 functions as the light incident window 102. The grid 402 is a focusing electrode.

The photoelectric conversion portion 403 is a reflective photocathode, for example, formed on a substrate made of metal. The photoelectric conversion portion 403 emits photoelectrons e in response to the light L2 incident through the side surface 401a of the bulb 401. The electrons emitted from the photoelectric conversion portion 403 are amplified by the plurality of dynodes 406.

The plurality of dynodes 406 emits secondary electrons in response to incidence of photoelectrons e from the photoelectric conversion portion 403, and multiplies the secondary electrons. The electron multiplier portion 110B includes, for example, the plurality of (eight in this example) dynodes 406. Each of the dynodes 406 is formed in a curved shape or a flat plate shape, and emits secondary electrons toward a dynode 406 at a subsequent stage upon collision with secondary electrons emitted from a dynode 406 at a previous stage. In this way, secondary electrons are sequentially multiplied. The multiplied secondary electrons are collected by the anode 405.

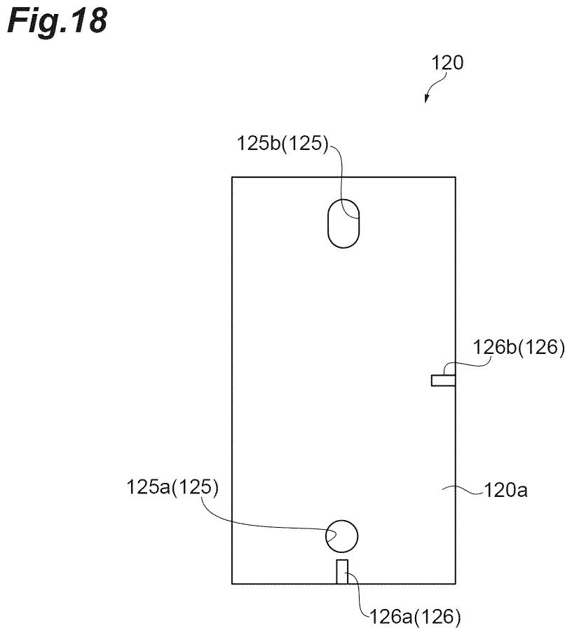

As illustrated in FIGS. 17 and 18, even in this case, the positioning member 120 can be configured similarly to the above embodiment. In this case, however, the first surface 120a of the positioning member 120 is curved to imitate the side surface 401a of the bulb 401. In this way, it is possible to fix the positioning member 120 to the bulb 401 while bringing the first surface 120a of the positioning member 120 into contact with the side surface 401a of the bulb 401 that functions as a light incident window. In this way, the electron tube 100B can be positioned easily and highly precisely, similarly to the electron tube 100. Specifically, by attaching the reference portion 125 of the positioning member 120 to the spectroscopic unit 2 as a mechanical reference, the spectroscopic unit 2 and the electron tube 100B (and further an internal structure such as the electron multiplier portion 110B, for example, in this embodiment, a reference line provided on the substrate of the photoelectric conversion portion 403 is aligned with a reference line provided on the positioning member 120) can be positioned with high precision.

As described above, the electron multiplier portion 110B does not have to have the plurality of channels ch. In this case, particularly when the effective surface is small, high-precision positioning is required, and thus this structure is effective.

Note that the positioning member 120 does not have to have a lens, and the reference portion 125 may have a single mechanical structure, instead of a plurality of mechanical structures such as the first through-hole 125a and the second through-hole 125b. In addition, the optical system 20 of the spectroscopic unit 2 does not have to have the filter 22, and even when the optical system 20 has the filter 22, the filter 22 may be at a previous stage of the diffraction grating 23, and may be disposed, for example, further at a previous stage of the collimating lens 21. The anti-reflection film 120s does not necessarily have to be formed on either the first surface 120a or the second surface 120b of the positioning member 120. The material of the positioning member 120 may be a material whose refractive index is close to that of the light incident window 102. Even in this case, it is possible to reduce reflection of light at the positioning member 120. Further, the cylindrical lens array (optical element) 122 may be an optical element having refractive power, which receives incidence of the light L2 from the spectroscopic unit 2 and emits the light L2 toward the light incident surface 102a. The cylindrical lens array (optical element) 122 may be a single lens that is not arrayed, or may be a Fresnel lens, a Gradient Index lens, a diffractive lens, or a focusing prism.

What is claimed is:

1. An electron tube used by being attached to an external device, the electron tube comprising:
a housing having a light incident window including a light incident surface and allowing light from the external device to be incident thereon through the light incident surface;
a photoelectric conversion portion disposed inside the housing to face the light incident window, and configured to emit electrons in response to the light incident from the light incident window;
an electron multiplier portion disposed inside the housing and configured to multiply electrons emitted from the photoelectric conversion portion; and
a positioning member formed separately from the light incident window and fixed to the light incident surface, the positioning member having a light passing portion passing the light from the external device toward the light incident surface,
wherein the positioning member has a reference portion serving as a reference for mechanical positioning with respect to the external device.

2. The electron tube according to claim 1, wherein the positioning member is fixed to the light incident surface so that the light passing portion faces the photoelectric conversion portion and the light passing through the light passing portion is incident on a desired region of the photoelectric conversion portion.

3. The electron tube according to claim 1, wherein a marker is formed on at least one of the positioning member, a substrate on which the photoelectric conversion portion is provided, and the electron multiplier portion.

4. The electron tube according to claim 1, wherein the electron multiplier portion has a plurality of channels arranged in at least one direction and used to multiply each of electrons emitted from the photoelectric conversion portion in response to each of a plurality of beams of the light incident from the light incident window.

5. The electron tube according to claim 1, wherein the positioning member has an optical element provided on the light passing portion and configured to receive incidence of the light from the external device and to emit the light toward the light incident surface.

6. The electron tube according to claim 1, wherein the reference portion has a position reference serving as a reference for a position with respect to the external device, and an angle reference serving as a reference for an angle with respect to the external device.

7. The electron tube according to claim 1, wherein the reference portion includes at least one of a protrusion, a hole, a notch, and an end surface formed on the positioning member.

8. The electron tube according to claim 1, wherein:
the positioning member has a first surface on a side of the light incident surface and a second surface on an opposite side from the first surface, and
an anti-reflection film is formed on at least one of the first surface and the second surface.

9. The electron tube according to claim 1, wherein an opening exposing the light incident surface toward an outside is formed in the light passing portion.

10. The electron tube according to claim 4, wherein:
the positioning member has an optical element provided on the light passing portion and configured to receive incidence of the light from the external device and to emit the light toward the light incident surface, and
the optical element includes a plurality of optical structures aligned with the plurality of channels, respectively.

11. The electron tube according to claim 10, further comprising a light-converging element provided on a surface of the optical element on an opposite side from the light incident surface and having a light-converging structure in a plane intersecting an arrangement direction of the channels.

12. A spectroscope comprising:
a spectroscopic unit as the external device for dispersing detection light into light of a plurality of wavelengths and emitting the light; and
the electron tube according to claim 1.

13. The spectroscope according to claim 12, wherein the spectroscopic unit comprises:
a dispersion element disposed on an optical path of the detection light and used to disperse the detection light into the light of the plurality of wavelengths; and
a wavelength selection element disposed at a previous stage of the dispersion element on the optical path of the detection light and configured to reflect or absorb light of a specific wavelength band of the detection light.
